(19) United States
(12) Patent Application Publication
(10) Pub. No.: US 2008/0276540 A1
(43) Pub. Date: Nov. 13, 2008

(54) Gasket of Door for Refrigerator and Making Method the Same

(75) Inventor: Young-Woo Kim, Gimhae-si (KR)

Correspondence Address: KED & ASSOCIATES, LLP, P.O. Box 221200, Chantilly, VA, 20153-1200, US

(73) Assignee: LG ELECTRONICS INC., Seoul City (KR)

(21) Appl. No.: 11/664,274

(22) PCT Filed: Jul. 10, 2006
(86) PCT No.: PCT/KR06/02705

§ 371 Date: Mar. 30, 2007

(30) Foreign Application Priority Data
Jul. 15, 2005 (KR) 10-2005-0064521

(51) Int. Cl. E06B 7/16; A47B 96/00; B29C 47/00

(52) U.S. Cl. 49/478.1; 312/405; 264/176.1

(57) ABSTRACT

The present invention relates to a door gasket and a method of manufacturing the same. In the present invention, an expansible insulating portion (24) is formed integrally with an anchor portion (22) of a door gasket (20), and the interior of the expansible insulating portion (24) is filled with a soft foam (28). The soft foam (28) is made of a soft material with superior insulation property. Here, the anchor portion (22) may be made of synthetic resin or rubber, and the soft foam (28) may be made of any one of soft urethane, polyethylene, ethylene propylene diene monomer rubber (EPDM rubber), nitrile butadiene rubber (NBR), and styrene butadiene rubber (SBR), such as compressed sponge.

### TECHNICAL FIELD

The present invention relates to a door gasket for a refrigerator, and more particularly, to a door gasket for preventing cold air leakage between a refrigerator main body and a door and a method of manufacturing the same.

### BACKGROUND ART

A refrigerator is provided with doors installed to a main body having storage spaces such as a freezing chamber and a refrigerating chamber to open and close the storage spaces. The doors are brought into close contact with a front surface of the refrigerator main body, thereby closing the freezing and refrigerating chambers from the outside. At this time, a door gasket is installed on a rear surface of the door for the door to be brought into close contact with the front surface of the refrigerator main body.

FIG. 1 is a sectional view of a state where a door with a door gasket mounted thereon is in close contact with a front surface of a refrigerator main body. According to the figure, a mounting groove 5 is formed along an edge of a rear surface of a refrigerator door 3 which is pivotably installed to a refrigerator main body 1, and a door gasket 7 is installed to the mounting groove 5. The door gasket 7 is formed by extruding rubber or soft synthetic resin.

The door gasket 7 is provided with an anchor portion 9 which is seated in the mounting groove 5, and the anchor portion 9 is integrally provided with a leakage preventing portion 11. The leakage preventing portion 11 is formed to be hollow and thus can be somewhat compressed between the main body 1 and the door 3. A magnet accommodating portion 13 which is brought into close contact with the refrigerator main body 1 is provided in a side of the leakage preventing portion 11. A magnet is installed within the magnet accommodating portion 13, so that the magnetic force bring the magnet accommodating portion 13 into close contact with the front surface of the refrigerator main body 1. To this end, a magnetic body is provided on the front surface of the refrigerator main body 1.

In a state where the refrigerator door 3 is closed, since the magnetic force of the magnet installed within the magnet accommodating portion 13 bring the refrigerator door 3 into close contact with the refrigerator main body 1, cold air is prevented from leaking between the door 3 and the refrigerator main body 1.

According to such a conventional configuration, although the leakage preventing portion 11 serves to prevent cold air from leaking between the refrigerator main body 1 and the door 3, it is impossible to prevent the heat transfer by conduction. That is, since the leakage preventing portion 11 is made of an expansible, soft material, the effect of blocking the heat transfer by conduction is deteriorated.

Therefore, although the conventional door gasket 7 serves to cause cold air not to leak directly to the outside, the gasket 7 does not prevent that the conduction causes the energy in the refrigerator to leak to the outside.

### DISCLOSURE

### Technical Problem

The present invention is conceived to solve the aforementioned problems in the prior art. An object of the present invention is to provide a door gasket for preventing the energy in a refrigerator from leaking to the outside.

Another object of the present invention is to provide a method of manufacturing a door gasket for preventing heat loss caused through conduction.

### Technical Solution

According to an aspect of the present invention for achieving the objects, there is provided a door gasket for sealing between a front surface of a refrigerator main body and a rear surface of a refrigerator door, comprising: an anchor portion to be fixed to the door or the refrigerator main body; and an expansible insulating portion formed integrally with the anchor portion and having insulating function and expansibility, the expansible insulating portion being compressed between the door and the refrigerator main body to prevent cold air leakage and heat loss.

Preferably, an interior of the expansible insulating portion are divided into one or more spaces, and the spaces between partitions dividing the expansible insulating portion are filled with a soft foam.

More preferably, the expansible insulating portion is further provided with a close contact portion, the close contact portion with a front surface formed to be plane being brought into close contact with the surface of the refrigerator main body or door.

Still more preferably, a magnet is further installed within the close contact portion, whereby magnetic force causes the close contact portion to be brought into close contact with the surface of the refrigerator main body or door.

Still more preferably, the anchor portion, and the partitions and the close contact portion of the expansible insulating portion are made of synthetic resin or rubber.

Still more preferably, the interior of the expansible insulating portion is filled with any one of soft urethane, polyethylene, ethylene propylene diene monomer rubber (EPDM rubber), nitrile butadiene rubber (NBR), and styrene butadiene rubber (SBR), such as compressed sponge.

According to another aspect of the present invention, there is provided a door gasket for sealing between a front surface of a refrigerator main body and a rear surface of a refrigerator door, comprising: an anchor portion to be fixed to the door or the refrigerator main body; and an expansible insulating portion made integrally with the anchor portion and of a soft insulation material to have insulating function and expansibility, the expansible insulating portion being compressed between the door and the refrigerator main body to prevent cold air leakage and heat loss.

Preferably, the expansible insulating portion comprises partitions made of a soft insulation material and an expansible space defined between the partitions.

More preferably, one or more of the expansible space are formed within the expansible insulating portion.

Still more preferably, the expansible insulating portion is made of a soft insulation material and the entire interior of the expansible insulating portion is filled with the soft insulation material.

Still more preferably, the expansible insulating portion is further provided with a close contact portion, the close contact portion with a front surface formed to be plane being brought into close contact with the surface of the refrigerator main body or door.

Still more preferably, a magnet is further installed within the close contact portion, whereby magnetic force causes the close contact portion to be brought into close contact with the surface of the refrigerator main body or door.

Still more preferably, the anchor portion and the close contact portion are made of synthetic resin or rubber.

Still more preferably, the expansible insulating portion is made of any one of soft urethane, polyethylene, ethylene propylene diene monomer rubber (EPDM rubber), nitrile butadiene rubber (NBR), and styrene butadiene rubber (SBR), such as compressed sponge.

According to a further aspect of the present invention, there is provided a method of extruding a door gasket for a refrigerator, the door gasket comprising an anchor portion to be fixed to a door or a refrigerator main body and an expansible insulating portion for preventing cold air leakage between the refrigerator main body and the door and performing insulating function, wherein the anchor portion and the expansible insulating portion are integrally formed of heterogeneous materials by applying separate pressures to the materials in a gel state for respectively forming the anchor portion and the expansible insulating portion and by causing them to pass through dies via separate paths at the same time.

Preferably, the expansible insulating portion comprises partitions made of the same material as the anchor portion and a soft foam made of a soft insulation material, and the expansible insulating portion is formed while the interior between the partitions is filled with the soft foam.

More preferably, the expansible insulating portion comprises partitions made of a soft insulation material different from the anchor portion and an expansible space providing reserve for the partitions to be expansible.

Still more preferably, a close contact portion is further provided along a side of the expansible insulating portion, the close contact portion and the expansible insulating portion being simultaneously formed, and a magnet is inserted into the close contact portion after the close contact portion is formed.

### ADVANTAGEOUS EFFECTS

According to a door gasket for a refrigerator of the present invention so configured and a method of manufacturing the same, it is possible to physically prevent cold air from leaking between a refrigerator main body and a door and at the same time to prevent the energy loss caused from conduction, thereby obtaining an effect in that operational characteristics of a refrigerator are improved. Also, according to a method of manufacturing a door gasket of the present invention, there is an advantage in that a door gasket with insulation property as well as expansibility can be manufactured.

### DESCRIPTION OF DRAWINGS

FIG. 1 is a sectional view showing that a door gasket according to a prior art prevents cold air from leaking between a refrigerator main body and a door;

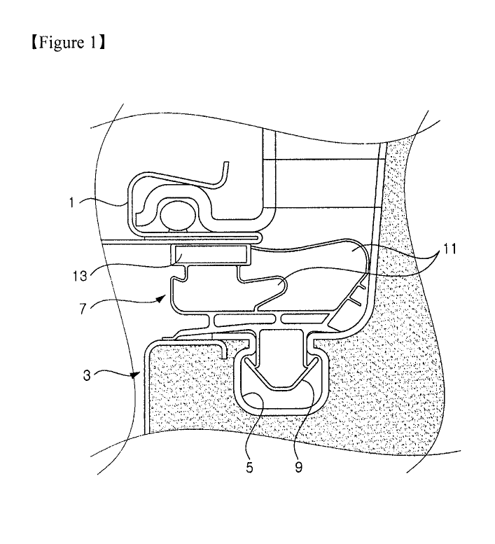

FIG. 2 is a sectional view showing a preferred embodiment of a door gasket according to the present invention; and

FIG. 3 is a sectional view showing another embodiment of a door gasket according to the present invention.

### BEST MODE

Hereinafter, preferred embodiments of a door gasket according to the present invention and a method of manufacturing the same will be described in detail with reference to the accompanying drawings.

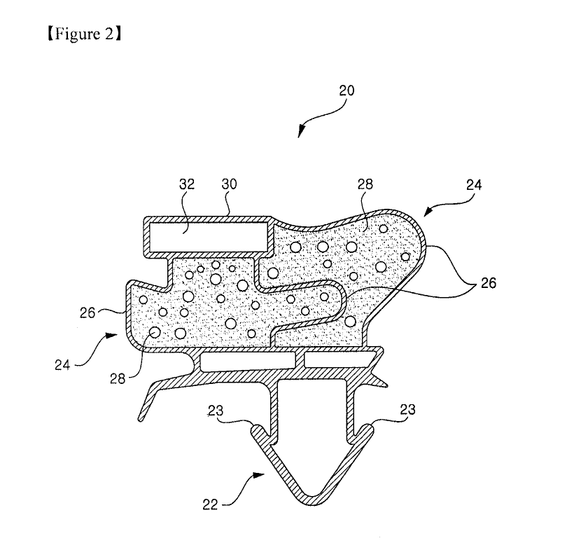

According to FIG. 2, a door gasket 20 of the present embodiment is formed to extend in a direction and has the same cross section at any portion. The door gasket 20 is manufactured by applying pressure to a material and causing it to pass through an opening portion of a die. That is, the door gasket 20 is manufactured by extrusion.

The door gasket 20 is provided with an anchor portion 22. The anchor portion 22 is a portion which is inserted into a mounting groove formed along an edge of the door and causes the door gasket 20 to be fixed to the door. Catching wings 23 are respectively formed on both ends of the anchor portion 22 so that the anchor portion 22 is inserted into the mounting groove and does not come out of it inadvertently.

The anchor portion 22 is provided with an expansible insulating portion 24 integrally. In the present embodiment, the expansible insulating portion 24 is divided into two spaces, but it is not necessarily so and one or more spaces may be formed therein depending on design conditions.

The expansible insulating portion 24 is formed by filling internal spaces defined by partitions 26 with soft foams 28. The partitions 26 are made of expansible synthetic resin or rubber like the anchor portion 22. The soft foams 28 have insulation property and softness and thus are also expansible.

For reference, the soft foam 28 will be described. The soft foam 28 can be made of soft urethane, polyethylene, EPDM, NBR, SBR or the like, such as compressed sponge with predetermined softness. That is, the soft foam 28 is formed of a material that has softness and superior insulation property. However, taking the operational characteristics of the door gasket 20 into consideration, hard foam cannot be used.

In the meantime, the expansible insulating portion 24 is integrally formed with a close contact portion 30. The close contact portion 30 is brought into close contact with the front surface of the refrigerator main body, wherein a portion facing the refrigerator main body is formed to be plane. A magnet 32 is installed within the close contact portion 30. The magnet 32 is attached by the magnetic force to a magnetic body provided on the front surface of the refrigerator main body and thus causes the close contact portion 30 to be brought into close contact with the refrigerator main body.

Of course, the close contact portion 30 with the magnet 32 need not be provided in the expansible insulating portion 24. That is, it is sufficient that the portion of the expansible insulating portion 24 which is brought into close contact with the refrigerator main body is configured to be plane. That is, if the expansible insulating portion 24 is compressed against and brought into close contact with the refrigerator main body and thus can prevent cold air from leaking, the close contact portion 30 need not be necessarily provided. The close contact portion 30 may be made of synthetic resin or rubber.

A process of manufacturing the door gasket of the present embodiment so configured will be described.

First, in the present embodiment, the anchor portion 22, the expansible insulating portion 24, and if necessary, the close contact portion are integrally formed of synthetic resin or rubber and the interior of the expansible insulating portion 24 is filled with the soft foams 28, whereby the door gasket 20 can be made. However, in such a case, the door gasket 20 cannot be manufactured at once and the expansible insulating portion 24 should be filled with the soft foams 28 after extruding the anchor portion 22, the expansible insulating portion 24 and the like, which is relatively inconvenient.

Thus, when manufacturing the door gasket 20, it can be simple to use a dual extrusion. In detail, two materials in an extrudable state are prepared. That is, synthetic resin or rubber for forming the anchor portion 22, the partitions 26 and the like, and the soft foams 28 are prepared.

Then, the two materials are caused to respectively pass through dies by applying separate pressures to the two materials, and the spaces defined by the partitions 26 are filled with the soft foams 28 after the two materials pass through the dies. That is, the process of forming the partitions 26 and the process of filling the spaces defined by the partitions 26 with the soft foams 28 are simultaneously performed. The materials are extruded after being formed in a gel state.

If using the dual extruding method, the anchor portion 22, the expansible insulating portion 24, and if necessary, the close contact portion 30 of the door gasket 20 can be simultaneously formed of two or more kinds of materials.

### MODE FOR INVENTION

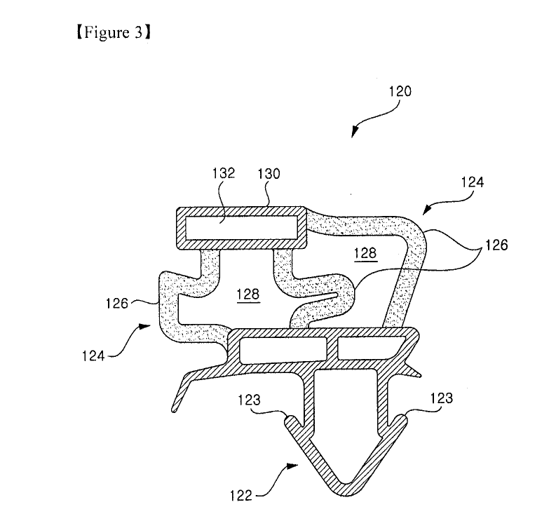

Another embodiment of a door gasket according to the present invention will be described with reference to FIG. 3. A door gasket 120 of the present embodiment, which is also formed to extend in a direction, has the same cross section at any portion. The door gasket 120 is manufactured by applying pressure to a material and causing it to pass through an opening portion of a die. That is, the door gasket 120 is manufactured by extruding.

The door gasket 120 is provided with an anchor portion 122. The anchor portion 122 is a portion which is inserted into a mounting groove formed along an edge of the door and causes the door gasket 120 to be fixed to the door. Catching wings 123 are respectively formed on both ends of the anchor portion 122 so that the anchor portion 122 is inserted into the mounting groove and does not come out of it inadvertently. The anchor portion 122 may be made of a material such as synthetic resin or rubber.

The anchor portion 122 is provided with an expansible insulating portion 124 integrally. In the present embodiment, the expansible insulating portion 124 is divided into two spaces, but it is not necessarily so and one or more spaces may be formed therein depending on design conditions.

The expansible insulating portion 124 is provided with partitions 126 made of an expansible material, and one or more expansible spaces 128 are defined within the expansible insulating portion 124. The expansible spaces 128 are reserved spaces for allowing the partitions 126 to be expansible. It is preferred that the partition 126 be formed to be relatively thicker than the partition 26 of the embodiment shown in FIG. 2. It is the reason why the partitions 126 should be expansible and simultaneously perform the insulating function.

In difference from the anchor portion 122 of synthetic resin or rubber, the partition 126 is made of a soft material with superior insulation property. For example, the partition 126 is made of a foam material which has softness and superior insulation property. The partitions 126 are formed of, for example, soft urethane, polyethylene, ethylene propylene diene monomer rubber (EPDM rubber), nitrile butadiene rubber (NBR), styrene butadiene rubber (SBR) or the like, such as compressed sponge with predetermined softness.

For reference, it is possible to make the entire of the expansible insulating portion 124 of a soft material with superior insulation property, such as soft foam. That is, the entire of the expansible insulating portion 124 without the expansible spaces 128 may be made of a soft insulation material. In such a case, as compared with the expansible insulating portion 124 with the expansible spaces 128, the expansible insulating portion 124 without the expansible spaces 128 is deteriorated in the expansibility but far increased in the insulation property.

In the meantime, the expansible insulating portion 124 is integrally formed with a close contact portion 130. The close contact portion 130 is brought into close contact with the front surface of the refrigerator main body, wherein a portion facing the refrigerator main body is formed to be plane. A magnet 132 is installed within the close contact portion 130. The magnet 132 is attached by the magnetic force to a magnetic body provided on the front surface of the refrigerator main body.

Of course, the close contact portion 130 with the magnet 132 need not be provided in the expansible insulating portion 124. That is, it is sufficient that the portion of the expansible insulating portion 124 which is brought into close contact with the refrigerator main body is configured to be plane. That is, if the expansible insulating portion 124 is compressed against and brought into close contact with the refrigerator main body and thus can prevent cold air from leaking, the close contact portion 130 need not be necessarily provided.

A process of manufacturing the door gasket of the present embodiment so configured will be described.

First, in the present embodiment, it is preferred that a dual extrusion be used since two kinds of materials are used for the door gasket 120. In detail, two materials in an extrudable state are prepared. That is, synthetic resin or rubber for forming the anchor portion 122 and soft foam for forming the partitions 126 are prepared.

Then, the two materials are caused to respectively pass through dies by applying separate pressures to the two materials. That is, the synthetic resin or rubber is caused to pass through the portion to be formed as the anchor portion 122, and the soft foam is caused to pass through the portion to be formed as the expansible insulating portion 124. The respective materials that have passed through the dies are cured in a state where they are connected to each other as shown in FIG. 3, thereby forming the door gasket 120. For reference, the materials are in a gel state when extruding.

If using the dual extruding method, the anchor portion 122, the expansible insulating portion 124, and if necessary, the close contact portion 130 of the door gasket 120 can be simultaneously formed of two or more kinds of materials.

The scope of the present invention is not limited to the embodiments described above but is defined by the claims. It will be apparent that those skilled in the art can make various modifications and changes thereto within the scope of the invention defined by the claims.

For example, the door gaskets 20 and 120 of the present invention need not be installed only to a rear surface of a door but may be fixed to a front surface of a refrigerator main body.

### INDUSTRIAL APPLICABILITY

A door gasket of the present invention with the configuration described above in detail can prevent cold air leakage between a refrigerator main body and a door and perform the insulating function, whereby it is possible to considerably contribute to increasing the efficiency of a refrigerator.

1. A door gasket for sealing between a front surface of a refrigerator main body and a rear surface of a refrigerator door, comprising:
an anchor portion to be fixed to the door or the refrigerator main body; and
an expansible insulating portion formed integrally with the anchor portion and having insulating function and expansibility, the expansible insulating portion being compressed between the door and the refrigerator main body to prevent cold air leakage and heat loss.

2. The door gasket as claimed in claim 1, wherein an interior of the expansible insulating portion are divided into one or more spaces, and the spaces between partitions dividing the expansible insulating portion are filled with a soft insulation material.

3. The door gasket as claimed in claim 1, wherein the expansible insulating portion is further provided with a close contact portion, the close contact portion with a front surface formed to be plane being brought into close contact with the surface of the refrigerator main body or door.

4. The door gasket as claimed in claim 3, wherein a magnet is further installed within the close contact portion, whereby magnetic force causes the close contact portion to be brought into close contact with the surface of the refrigerator main body or door.

5. The door gasket as claimed in claim 4, wherein the anchor portion, and the partitions and the close contact portion of the expansible insulating portion are made of synthetic resin or rubber.

6. The door gasket as claimed in claim 5, wherein the interior of the expansible insulating portion is filled with any one of soft urethane, polyethylene, ethylene propylene diene monomer rubber (EPDM rubber), nitrile butadiene rubber (NBR), and styrene butadiene rubber (SBR), such as compressed sponge.

7. A door gasket for sealing between a front surface of a refrigerator main body and a rear surface of a refrigerator door, comprising:
an anchor portion to be fixed to the door or the refrigerator main body; and
an expansible insulating portion made integrally with the anchor portion and of a soft insulation material to have insulating function and expansibility, the expansible insulating portion being compressed between the door and the refrigerator main body to prevent cold air leakage and heat loss.

8. The door gasket as claimed in claim 7, wherein the expansible insulating portion comprises partitions made of a soft insulation material and an expansible space defined between the partitions.

9. The door gasket as claimed in claim 8, wherein one or more of the expansible space are formed within the expansible insulating portion.

10. The door gasket as claimed in claim 7, wherein the expansible insulating portion is made of a soft insulation material and the entire interior of the expansible insulating portion is filled with the soft insulation material.

11. The door gasket as claimed in claim 7, wherein the expansible insulating portion is further provided with a close contact portion, the close contact portion with a front surface formed to be plane being brought into close contact with the surface of the refrigerator main body or door.

12. The door gasket as claimed in claim 1, wherein a magnet is further installed within the close contact portion, whereby magnetic force causes the close contact portion to be brought into close contact with the surface of the refrigerator main body or door.

13. The door gasket as claimed in claim 12, wherein the anchor portion and the close contact portion are made of synthetic resin or rubber.

14. The door gasket as claimed in claim 13, wherein the expansible insulating portion is made of any one of soft urethane, polyethylene, ethylene propylene diene monomer rubber (EPDM rubber), nitrile butadiene rubber (NBR), and styrene butadiene rubber (SBR), such as compressed sponge.

15. A method of extruding a door gasket for a refrigerator, the door gasket comprising an anchor portion to be fixed to a door or a refrigerator main body and an expansible insulating portion for preventing cold air leakage between the refrigerator main body and the door and performing insulating function,
wherein the anchor portion and the expansible insulating portion are integrally formed of heterogeneous materials by applying separate pressures to the materials in a gel state for respectively forming the anchor portion and the expansible insulating portion and by causing them to pass through dies via separate paths at the same time.

16. The method as claimed in claim 15, wherein the expansible insulating portion comprises partitions made of the same material as the anchor portion and a soft foam made of a soft insulation material, and the expansible insulating portion is formed while the interior between the partitions is filled with the soft foam.

17. The method as claimed in claim 15, wherein the expansible insulating portion comprises partitions made of a soft insulation material different from the anchor portion and an expansible space providing reserve for the partitions to be expansible.

18. The method as claimed in claim 15, wherein a close contact portion is further provided along a side of the expansible insulating portion, the close contact portion and the expansible insulating portion being simultaneously formed, and a magnet is inserted into the close contact portion after the close contact portion is formed.
